(19) United States
(12) Patent Application Publication
(10) Pub. No.: US 2009/0174560 A1
(43) Pub. Date: Jul. 9, 2009

(54) Systems, Apparatuses And Methods For Monitoring Physical Conditions Of A Vehicle Driver

(75) Inventors: Fawad Ahmad, Schaumburg, IL (US); Senthilnathan Sundaram, Vernon Hills, IL (US); Tushad Driver, Streamwood, IL (US); Weidong Zhao, Gurnee, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/968,785

(22) Filed: Jan. 3, 2008

(51) Int. Cl. G08B 23/00

(52) U.S. Cl. 340/576

(57) ABSTRACT

Embodiments of the present technology provide apparatuses, systems and methods for monitoring physical conditions of a vehicle driver.

### BACKGROUND OF THE INVENTION

Generally, the technical field involves systems, apparatuses and methods for monitoring physical conditions of a vehicle driver.

There are over 6 million auto accidents in the United States in every year. The financial cost of these crashes is more than 230 Billion dollars. Almost 3 million people are injured and about 40,000 people are killed every year. That means about 115 people die every day in vehicle crashes in the United States. This equates to one death every 13 minutes.

There are a number of causes of automobile accidents. Many accidents today are caused by sudden change in health conditions, drowsiness or lack of consciousness from the driver while driving. For example, drivers with heart or other health conditions could suffer a heart attack or similar emergency situation rendering them unconscious or otherwise unable to drive. This is also true of older drivers whose health may be more volatile than younger drivers. In another example, individuals driving long distances or late hours may become drowsy and nod off during driving creating a potentially life threatening situation.

### BRIEF SUMMARY OF THE INVENTION

Certain embodiments of the present technology provide systems, apparatuses and methods for monitoring physical conditions of a vehicle driver.

Certain embodiments of the present system for monitoring physical conditions of a vehicle driver comprise a vehicle control having embedded touch sensors wherein said touch sensors detect parameters dealing with a vehicle driver's physical condition; a receiver wherein said receiver monitors said detected parameters from said touch sensors for a presence of an alert event related to said vehicle driver's physical condition; a transmitter wherein said transmitter receives said presence of alert events from said receiver and transmits said presence of alert events; and a response device wherein said response device receives said presence of alert events and provides a response to said alert events.

Certain embodiments of the present method for monitoring physical conditions of a vehicle driver comprise detecting parameters dealing with a vehicle driver's physical condition using touch sensors embedded in a vehicle control; monitoring said detected parameters for a presence of alert events in said detected parameters based on said vehicle driver's physical condition; transmitting said presence of alert events to a response device; and triggering a response event using said response device.

These and other features of the present invention are discussed or apparent in the following detailed description.

### BRIEF DESCRIPTION OF SEVERAL VIEWS OF THE DRAWINGS

FIG. 1 illustrates a system for monitoring physical conditions of a vehicle driver according to an embodiment of the present technology.

FIG. 2 illustrates a flow diagram for a method of monitoring physical conditions of a vehicle driver according to an embodiment of the present technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The current technology relates to systems, apparatuses and methods for monitoring physical conditions of a vehicle driver. Although certain particulars are used as examples, the current technology should not be viewed as limited to such systems.

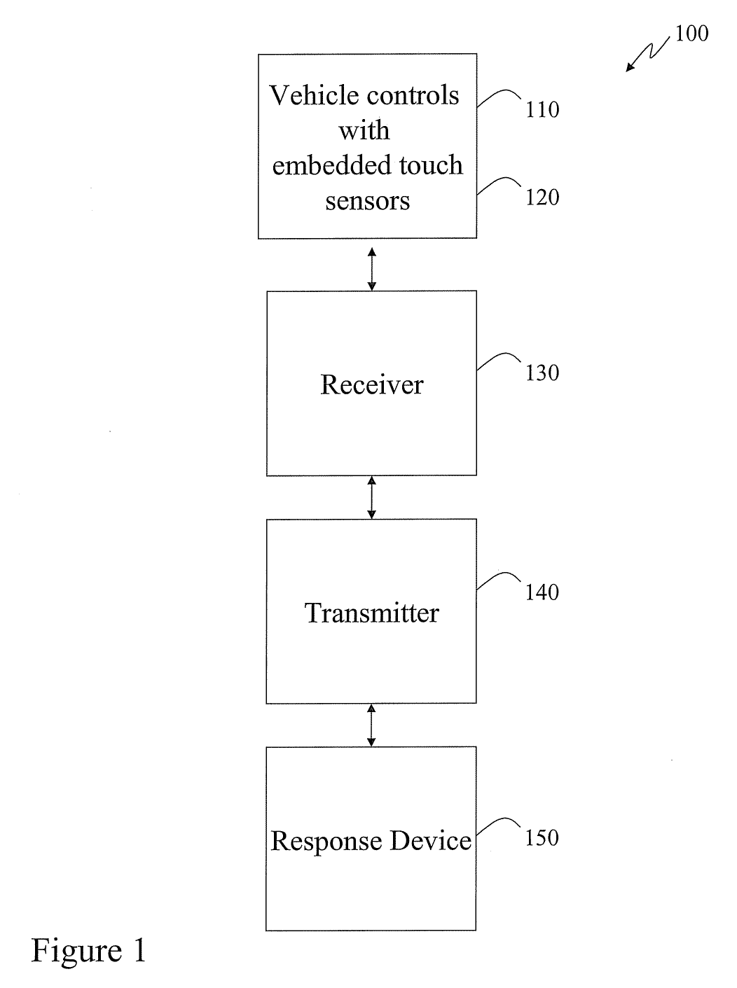

FIG. 1 illustrates a system (100) for monitoring physical conditions of a vehicle driver according to an embodiment of the present technology. In one embodiment, the present system (100) comprises a vehicle control (110) having embedded touch sensors (120), a receiver (130), a transmitter (140) and a response device (150). The touch sensors (120) are in communication with the receiver (130). The receiver (130) is in communication with the transmitter (140). The transmitter (140) is in communication with the response device (150).

The components of the system (100) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer. Certain embodiments may omit one or more of the components of the system (100).

The current system (100) is comprised of a vehicle control (110) having embedded touch sensors (120). The vehicle control (110) could be any mechanism for controlling a vehicle. For example, the vehicle control (110) could be a steering wheel or other steering mechanism. The vehicle control (110) could be a component of any type of vehicle. Non-limiting examples of the type of vehicles include automobiles, motorcycles, airplanes, four wheelers, ski mobiles, and jet skis.

The vehicle control (110) has embedded touch sensors (120). The touch sensors (120) could be located in different places on the vehicle control (110). For example the touch sensors (120) could be inside of the vehicle control (110), on top of the vehicle control (110), or under the vehicle control (110). The touch sensors (120) could be randomly arranged or arranged in some pattern. The touch sensors (120) could be more heavily located in a certain area of the vehicle control than in other areas. For example touch sensors could be arranged in areas where a person is likely to hold onto a steering wheel.

The touch sensors (120) monitor physical conditions of a vehicle driver. Specifically, the touch sensors (120) detect various parameters dealing with the vehicle driver's physical condition. The touch sensors (120) could be used to measure a variety of parameters dealing with the vehicle driver's physical condition. For example, the touch sensors (120) could measure pulse, temperature, respiration rate or blood pressure. Various types of touch sensors (120) that are known to those familiar with the technology could be used. For example, hand pulse reading sensors, infrared or laser sensors could be used. There can be one type of touch sensor (120) or multiple types of touch sensors (120) in any one vehicle control (110). In one embodiment hand pulse reading sensors are embedded in a steering wheel. When the vehicle driver holds the steering wheel, the touch sensors detect the driver's pulse.

The touch sensors (120) are in communication with a receiver (130). Various types of receivers (130) that are known to those familiar with the technology could be used. For example radio frequency (RF) receivers, frequency modulation (FM) receivers or any receiver built to process the sensors (120) discussed above could be used. The touch sensors (120) communicate the detected parameters to the receiver (130). The receiver (130) receives these detected parameters from the touch sensors (140). The receiver (130) monitors the detected parameters.

The receiver (130) monitors the detected parameters for the presence of an alert event or alert events related to the vehicle driver's physical condition. An alert event could be disappearance of a certain parameter, a certain parameter reaching an upper limit or a certain parameter reaching a lower limit. For example, the alert event could be disappearance of the vehicle driver's pulse. In other examples, the alert events could be the vehicle driver's pulse raising above an upper limit or falling below a lower limit. The alert events could be pre-programmed values and/or could be user programmable.

The receiver (130) is in communication with a transmitter (140). Various types of transmitters (140) that are known to those familiar with the technology could be used. For example frequency modulation (FM) transmitters, radio frequency (RF) transmitters or global positioning system (GPS) transmitters could be used. The receiver (130) communicates the presence of an alert event to the transmitter (140). The transmitter (140) receives the presence of the alert event from the receiver (130). The transmitter (140) and the receiver (130) can be separate devices or a single device.

The transmitter (140) is in communication with a response device (150). Various types of response devices (150) that are known to those familiar with the technology could be used. For example a navigation or LCD screen in the car or delivering via audio in a car (such as many radar detector systems have today) could be used. The transmitter (140) transmits the presence of an alert event to a response device (150). The response device (150) receives the presence of the alert event from the transmitter (140). The response device (150) provides a response to the alert event. The presence of alert events could trigger various responses.

As one example the response could be directed towards getting the driver's attention. For example, the interior lights could flash, the volume of music could increase, the windows could automatically roll down, the level of air conditioning could increase, or the horn could automatically sound. Multiple response events could occur simultaneously or in succession. These responses would be particularly helpful in the case of a sleeping, drowsy or inattentive driver.

In another example the response could be directed towards alerting authorities of the dangerous condition. For example, an Emergency Response System could be contacted when an alert event is detected. The Emergency Response System could be contacted via phone, fax, e-mail, etc. This would alert authorities of the dangerous condition of the driver. A global positions system (GPS) could also be used with the reporting function to determine the location of the driver. Knowing the location would allow the Emergency Response System to quickly respond to the situation.

False reports to an Emergency Response System might occur if a person was not touching the embedded touch sensors (120). Avoiding false reports to an Emergency Response System would be desirable. In order to do so the system could issue a warning first. The warning could be similar to the responses directed towards getting the driver's attention discussed above. The warning could also be a message on a navigation or LCD screen in the car. These warnings would allow the driver to touch the embedded touch sensors (120) and avoid a false report to an Emergency Response System.

Another situation where false reports could occur is where there was no occupant in the vehicle. In order to avoid this type of false report, the system (100) could have additional components for determining the presence of an individual in the car. These components could be implemented alone or in combination in hardware, firmware, and/or as a set of instructions in software, for example. Where an individual is not present in the car, a report to an Emergency Response System would not be sent.

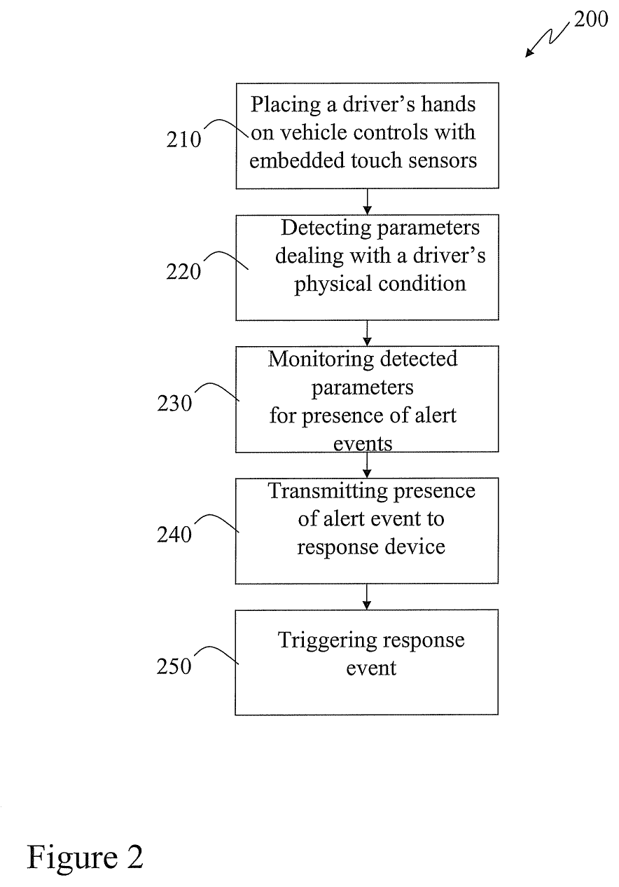

FIG. 2 illustrates a method (200) of monitoring physical conditions of a vehicle driver according to an embodiment of the present technology. The method (200) involves placing a driver's hands on a vehicle control with embedded touch sensors (210); detecting parameters dealing with a vehicle driver's physical condition using touch sensors embedded in a vehicle control (220); monitoring the detected parameters for a presence of alert events in the detected parameters based on the vehicle driver's physical condition (230); transmitting the presence of alert events to a response device (240); and triggering a response event using the response device (250).

In the first step the driver's hands (or other body part) are placed on a vehicle control with embedded touch sensors (210). The vehicle control with embedded touch sensors may take the form of the vehicle control with embedded touch sensors discussed above, such as (110) and (120). The vehicle control could be any mechanism for controlling a vehicle. For example, the vehicle control could be a steering wheel or other steering mechanism. The vehicle control could be components of any type of vehicle, such as automobiles, motorcycles, airplanes, four wheelers, ski mobiles, and jet skis.

Various types of touch sensors that are known to those familiar with the technology could be used such as hand pulse reading sensors, infrared or laser sensors. There can be one type of touch sensor or multiple types of touch sensors in any one vehicle control. In one embodiment hand pulse reading sensors are embedded in a steering wheel.

The touch sensors could be located in different places on the vehicle control. For example the touch sensors could be inside of, on top of, or under the vehicle control. The touch sensors could be randomly arranged or arranged in some pattern. The touch sensors could be more heavily located in a certain area of the vehicle control such as where a person is likely to hold onto a steering wheel.

In the next step parameters dealing with a vehicle driver's physical condition are detected using touch sensors embedded in a vehicle control (220). The vehicle control with embedded touch sensors may take the form of the vehicle control with embedded touch sensors, such as (110) and (120) discussed above. The touch sensors monitor physical conditions of the vehicle driver. Specifically, the touch sensors detect various parameters dealing with the vehicle driver's physical condition. The touch sensors could be used to measure a variety of parameters dealing with the vehicle driver's physical condition such as pulse, temperature, respiration rate or blood pressure. In one example, when the vehicle driver holds the steering wheel, the touch sensors detect the driver's pulse.

In the next step the detected parameters are monitored for a presence of alert events in the detected parameters based on the vehicle driver's physical condition (230). An alert event could be disappearance of a certain parameter, a certain parameter reaching an upper limit or a certain parameter reaching a lower limit. For example, the alert event could be disappearance of the vehicle driver's pulse. In other examples, the alert events could be the vehicle driver's pulse raising above an upper limit or falling below a lower limit. The alert events could be pre-programmed values and/or could be user programmable.

The monitoring for alert events may be carried out using a receiver, such as (130) discussed above. Various types of receivers that are known to those familiar with the technology could be used such as radio frequency (RF) receivers, frequency modulation (FM) receivers or any receiver built to process the sensors (120) discussed above. The touch sensors would communicate the detected parameters to the receiver. The receiver would receive these detected parameters from the touch sensors. The receiver would monitor the detected parameters for the presence of an alert event.

In the next step the presence of alert events is transmitted to a response device (240). The transmitting may be carried out using a transmitter, such as (140) discussed above. Various types of transmitters (140) that are known to those familiar with the technology could be used. For example frequency modulation (FM) transmitters, radio frequency (RF) transmitters or global positioning system (GPS) transmitters could be used. The receiver could communicate the presence of an alert event to the transmitter. The transmitter could then receive the presence of the alert event from the receiver.

In the next step a response event is triggered using the response device (250). The response device may take the form of a response device discussed above, such as (150). Various types of response devices that are known to those familiar with the technology could be used such as a navigation or LCD screen in the car or delivering via audio in a car (such as many radar detector systems have today). The transmitter could transmit the presence of an alert event to a response device. The response device could receive the presence of the alert event from the transmitter. The response device could provide a response to the alert event. The presence of alert events could trigger various responses.

As discussed above, the response could be directed towards getting the driver's attention. For example, the interior lights could flash, the volume of music could increase, the windows could automatically roll down, the level of air conditioning could increase, or the horn could automatically sound. Multiple response events could occur simultaneously or in succession. These responses would be particularly helpful in the case of a sleeping, drowsy or inattentive driver.

As discussed above, the response could also be directed towards alerting others of the dangerous condition. For example, an Emergency Response System could be contacted when an alert event is detected. The Emergency Response System could be contacted via phone, fax, e-mail, etc. This would alert authorities of the dangerous condition of the driver. A global positions system (GPS) could also be used with the reporting function to determine the location of the driver. Knowing the location would allow the Emergency Response System to quickly respond to the situation.

False reports could be avoided as discussed above. A warning could be issued prior to alerting the Emergency Response System. The warming could be similar to the responses directed towards getting the driver's attention discussed above. The warning could also be a message on a navigation or LCD screen in the car. These warnings would allow the driver to touch the embedded touch sensors and avoid a false report to an Emergency Response System. There could also be steps in the method for determining the presence of an individual in the car. These steps could be implemented alone or in combination in hardware, firmware, and/or as a set of instructions in software, for example. Where an individual is not present in the car, a report to an Emergency Response System would not be sent.

One or more of the steps of the methods (200) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (200) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In one example, hand pulse sensors are built into the steering wheel of a car. When the driver holds onto the steering wheel the touch sensors detect the driver's pulse. The receiver monitors the driver's pulse. If the driver's pulse rate drops or stops completely, the transmitter alerts the response device. The response device issues a warning by lowering the windows and turning up the music in an attempt to get the driver's attention. If the driver's pulse does not increase, the response device sends and e-mail message to an Emergency Response System. The e-mail message discloses the location of the car using GPS.

Thus, certain embodiments provide the technical effect of monitoring physical conditions of a vehicle driver

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

1. A system for monitoring physical conditions of a vehicle driver comprising:
a vehicle control having embedded touch sensors wherein said touch sensors detect parameters dealing with a vehicle driver's physical condition;
a receiver wherein said receiver monitors said detected parameters from said touch sensors for a presence of an alert event related to said vehicle driver's physical condition;
a transmitter wherein said transmitter receives said presence of alert events from said receiver and transmits said presence of alert events; and
a response device wherein said response device receives said presence of alert events and provides a response to said alert events.

2. The system of claim 1 wherein said vehicle control is a steering wheel.

3. The system of claim 1 wherein said vehicle is an automobile.

4. The system of claim 1 wherein said touch sensors are hand pulse sensors.

5. The system of claim 1 wherein said alert event is a drop in pulse rate.

6. The system of claim 1 wherein said alert events are user programmable.

7. The system of claim 1 wherein said response is an event directed towards getting the driver's attention.

8. The system of claim 1 wherein said response is alerting and Emergency Response System.

9. The system of claim 8 wherein said response includes alerting said Emergency Response System of the vehicle's location.

10. A system for monitoring physical conditions of a vehicle driver comprising:
a steering wheel having embedded hand pulse sensors wherein said hand pulse sensors detect the vehicle driver's pulse rate;
a receiver wherein said receiver monitors said vehicle driver's pulse rate for a change in said pulse rate;
a transmitter wherein said transmitter receives said change in said pulse rate from said receiver and transmits said change in said pulse rate; and
a response device wherein said response device receives said change in said pulse rate and provides a response to said change in said pulse rate.

11. A method of monitoring physical conditions of a vehicle driver comprising:
detecting parameters dealing with a vehicle driver's physical condition using touch sensors embedded in a vehicle control;
monitoring said detected parameters for a presence of alert events in said detected parameters based on said vehicle driver's physical condition;
transmitting said presence of alert events to a response device; and
triggering a response event using said response device.

12. The method of claim 11 wherein the steps are performed sequentially.

13. The method of claim 11 wherein said vehicle control is a steering wheel.

14. The method of claim 11 wherein said vehicle is an automobile.

15. The method of claim 11 wherein said touch sensors are hand pulse sensors.

16. The method of claim 11 wherein said alert event is a drop in pulse rate.

17. The method of claim 11 wherein said alert events are user programmable.

18. The method of claim 11 wherein said response is an event directed towards getting the driver's attention.

19. The method of claim 11 wherein said response is alerting and Emergency Response System.

20. The method of claim 11 wherein said response includes alerting said Emergency Response System of the vehicle's location.
